(19) United States
(12) Patent Application Publication
(10) Pub. No.: US 2022/0305998 A1
(43) Pub. Date: Sep. 29, 2022

(54) DIMMABLE CAR EXTERNAL REARVIEW MIRROR DEVICE

(71) Applicant: Wicue, Inc., Cupertino, CA (US)

(72) Inventor: Fenghua LI, Cupertino, CA (US)

(21) Appl. No.: 17/656,157

(22) Filed: Mar. 23, 2022

Related U.S. Application Data
(60) Provisional application No. 63/164,753, filed on Mar. 23, 2021.

(51) Int. Cl. B60R 1/08; G02F 1/1335; G02F 1/1337; G02F 1/13363; G02F 1/137; G02F 1/133; B60R 1/06

(52) U.S. Cl. CPC B60R 1/088; G02F 1/133553; G02F 1/1337; G02F 1/133638; G02F 1/13725; G02F 1/13318; B60R 1/06; G02F 2202/04; G02F 2203/02

(57) ABSTRACT

An apparatus for proving a dimmable reflection and having a layered structure comprises a curved reflective layer, a curved cover glass layer, and at least one liquid crystal film positioned between the curved reflective layer and the curved cover glass layer. Each of the at least one liquid crystal film may comprise a first substrate layer, a first conductive layer, a first alignment layer, a guest host liquid crystal layer, a second alignment layer, a second conductive layer, and a second substrate layer and may be operable in (1) a vertical state, in which liquid crystal molecules are oriented in a direction perpendicular to a plane, associated with a first reflectivity rate and (2) a planar state, in which the liquid crystal molecules are oriented in a direction parallel to the plane, associated with a second overall reflectivity rate lower than the first reflectivity rate.

### BACKGROUND

### 1. Field of Disclosure

The present disclosure relates to the field of light reflection devices, and particularly relates to dimmable light reflection devices, such as an automotive exterior rearview mirror device. In some embodiments, the device implements automatic adjustment of reflectivity according to a detected intensity of light, e.g., from the rear of a vehicle, and can effectively protect a driver of the vehicle from the interference of strong light from the rear of the vehicle.

### 2. Description of Related Art

Traditional dimmable automotive interior rearview mirror uses electrochromic dimming technology. When the interior rearview mirror light-sensitive components receive a certain intensity of light from the rear of the car, a driver module outputs a driving current to induce an electrochemical reaction in an electrochromic medium layer, which undergoes a color change from a transparent state to a dark state, thus adjusting the reflectivity of the rearview mirror. However, such electrochromic technology is generally complicated and associated with high cost. Also, low reflectivity is typically not low enough, and the response speed is slow, usually up to 6 seconds. Furthermore, strong light from the rear of the vehicle generally cannot be well blocked quickly, which can pose a safety hazard.

### BRIEF SUMMARY

The present disclosure provides a dimmable reflective device generally. In some embodiments, the present disclosure provides a dimmable mirror. For instance, the dimmable mirror may be used as an automotive exterior rearview mirror device. The dimming device may include a cover glass layer, one or more liquid crystal films, and a reflective layer, such as a mirror. When a light-sensitive element senses strong light from the rear of the vehicle, such as the strong light from another vehicle's high beam at night, the corresponding signal can be fed back to the driving system, and the driving system outputs the corresponding intensity of an electric field to drive the one or more liquid crystal layers to realize the reflectivity adjustment of the rearview mirror. Such an arrangement may effectively protect the driver from the interference of the strong light from the rear of the vehicle and effectively improve the night driving safety.

An example apparatus for proving a dimmable reflection and having a layered structure comprises a curved reflective layer, a curved cover glass layer, and at least one liquid crystal film positioned between the curved reflective layer and the curved cover glass layer. Each of the at least one liquid crystal film may comprise a first substrate layer, a first conductive layer, a first alignment layer, a guest host (GH) liquid crystal layer comprising liquid crystal molecules and dichroic dye molecules, a second alignment layer, a second conductive layer, and a second substrate layer. Each of the at least one liquid crystal film may be operable in (1) a vertical state in which the liquid crystal molecules are oriented in a direction perpendicular to a plane corresponding to the liquid crystal film and the layered structure is associated with a first reflectivity rate and (2) a planar state in which the liquid crystal molecules are oriented in a direction parallel to the plane corresponding to the liquid crystal film and the layered structure is associated with a second overall reflectivity rate lower than the first reflectivity rate.

### BRIEF DESCRIPTION OF THE DRAWINGS

FIG. 1A presents a frontal view of a curved reflection device according to an embodiment of the disclosure.

FIG. 1B presents a frontal view of internal components of an external rearview mirror, according to an embodiment of the disclosure.

FIG. 2 is a cross-sectional view showing certain parts of the layered structure of a dimmable reflection device incorporating a liquid crystal film, according to some embodiments of the disclosure.

FIG. 3 is different cross-sectional view showing certain parts of the layered structure of the dimmable reflection device incorporating a liquid crystal film, according to some embodiments of the disclosure.

FIG. 4 is a cross-sectional view showing certain parts of the layered structure of a dimmable reflection device incorporating a liquid crystal film and a quarter-wave plate, according to some embodiments of the disclosure.

FIG. 5 is different cross-sectional view showing certain parts of the layered structure of the dimmable reflection device incorporating a liquid crystal film and a quarter-wave plate, according to some embodiments of the disclosure.

FIG. 6 illustrates the vertical state of the liquid crystal film within the layered structure of the dimmable reflection device incorporating a liquid crystal film and a quarter-wave plate, according to some embodiments of the disclosure.

FIG. 7 illustrates the planar state of the liquid crystal film within the layered structure of the dimmable reflection device incorporating a liquid crystal film and a quarter-wave plate, according to some embodiments of the disclosure.

FIG. 8 illustrates the vertical state of the liquid crystal film within the layered structure of a dimmable reflection device incorporating a liquid crystal film comprising cholesteric liquid crystal molecules having a helical structure, according to some embodiments of the disclosure.

FIG. 9 illustrates the planar state of the liquid crystal film within the layered structure of a dimmable reflection device incorporating the liquid crystal film comprising cholesteric liquid crystal molecules having a helical structure, according to some embodiments of the disclosure.

FIG. 10 illustrates the vertical state of a first liquid crystal film and a second liquid crystal film within the layered structure of a dimmable reflection device, according to some embodiments of the disclosure.

FIG. 11 illustrates the planar state of a first liquid crystal film and a second liquid crystal film within the layered structure of a dimmable reflection device, according to some embodiments of the disclosure.

### DETAILED DESCRIPTION

Embodiments of the present disclosure provide a dimmable mirror device (e.g., exterior rearview mirror device), which can realize automatic adjustment of reflectivity according to the intensity of light (e.g., from the rear of the vehicle). Embodiments of the disclosure can, for example, effectively protect the driver from the interference of strong light from the rear of the vehicle. According to various embodiments, a reflection device for proving a dimmable reflection and having a layered structure is disclosed. The reflection device may be used in a vehicular application and may be implemented in an interior and/or exterior region of a vehicle. For example, embodiments of the reflection device may be implemented as an interior rearview mirror and/or an exterior side mirror for a vehicle.

In some embodiments, the layered structure of the reflection device comprises a curved reflective layer, a curved cover glass layer, and at least one liquid crystal film positioned between the curved reflective layer and the curved cover glass layer. Each of the at least one liquid crystal film may comprise a first substrate layer, a first conductive layer, a first alignment layer, a guest host (GH) liquid crystal layer comprising liquid crystal molecules and dichroic dye molecules, a second alignment layer, a second conductive layer, and a second substrate layer. Each of the at least one liquid crystal film may be operable in (1) a vertical state in which the liquid crystal molecules are oriented in a direction perpendicular to a plane corresponding to the at least one liquid crystal film and the layered structure is associated with a first reflectivity rate and (2) a planar state in which the liquid crystal molecules are oriented in a direction parallel to the plane corresponding to the liquid crystal film and the layered structure is associated with a second overall reflectivity rate lower than the first reflectivity rate.

In certain embodiments, a liquid crystal dimming film comprising GH liquid crystals is used. In other embodiments, other types of liquid crystal dimming films may be used, such as a twisted nematic (TN) liquid crystal dimming film, a vertical alignment (VA) liquid crystal dimming film, and/or others.

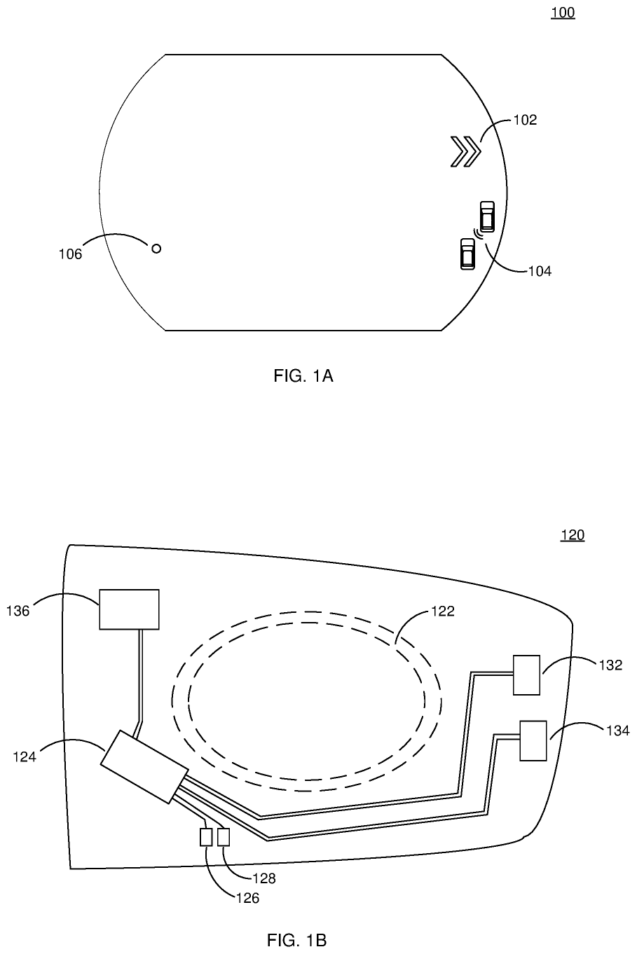

FIG. 1A presents a frontal view of a curved reflection device 100 according to an embodiment of the disclosure. The curved reflection device 100 may be utilized as an external rearview mirror mounted on a side of a vehicle, for instance. The frontal view presented in FIG. 1A represents a view from the perspective of a driver looking at the curved reflection device 100 in a typical scenario. As a side-mounted external rearview mirror, the curved reflection device 100 provides the driver with a wide-angle view of the scene behind as well as to one side of the vehicle. Here, term “curved” is used to refer broadly to different types of curvatures in three-dimensional space. Examples of different types of curvatures include (but are not limited to) spherical, ellipsoidal, and cylindrical curved surfaces.

As shown, the curved reflection device 100 also incorporates a turn signal light 102, a blind-spot detector light 104, and a light sensor 106. The turn signal light 102 may comprise one or more light sources such as light-emitting diodes (LEDs) that may blink to indicate an intention of the driver of the vehicle to make a turn toward the side of the vehicle on which the curved reflection device 100 is located. The blind-spot detector light 104 may comprise one or more light sources such as LEDs that may turn on to indicate the presence of an object (e.g., another vehicle) in a blind spot of the driver. Such a blind-spot detector light 104 may provide added safety, by warning the driver that a vehicle that is in the driver's blind spot and not visible to the driver is close by. The light sensor 106 may be used to provide a measurement of the intensity of external light, such as glare from another vehicle's headlights. The measurement of the intensity of the external light may be used as an input to control the reflectivity rate of the curved reflection device 100. If an external light is relatively dim (i.e., not intense), the reflectivity rate may be adjusted to a high level, to provide a highly reflective surface and enhance the view of the rear of the vehicle presented to the driver. If the external light is relatively bright (i.e., intense), the reflectivity may be adjusted to a low level, to provide a less reflective surface and protect the driver's eyes from being blinded or impaired (“dazzled”) by intense light and allow the driver to still be able to view the reflection presented by the curved reflection device 100.

FIG. 1B presents a frontal view of internal components of an external rearview mirror 120, according to an embodiment of the disclosure. The external rearview mirror 120 comprises a mounting plate 122, a printed circuit board (PCB) 124, a pair of liquid crystal film connectors 126 and 128, a turn signal light connector 132, a blind-spot detector light connector 134, and a mirror heater/defogger connector 136. Typically, a reflection device, such as the curved reflection device 100, shown in FIG. 1A positioned over and covers the internal components shown in FIG. 1B. Such a reflection device may be mounted on the mounting plate 122. The PCB 124 receives input signals and generates output signals to support the various operations of the curved reflection device 100. For example, a light sensor such as light sensor 106 shown in FIG. 1A (not shown in FIG. 1B) may be mounted on the PCB 124 and provide external light intensity measurements as input signals to the PCB 124. Based on such external light intensity measurements, control circuitry implemented on the PCB 124 may generate appropriate voltages as output signals provided to the liquid crystal film connectors 126 and 128. These output signals may drive liquid crystal conductor layers (discussed later), to drive one or more liquid crystal films of the curved reflection device 100 and adjust the reflectivity rate to appropriate levels (e.g., high reflectivity for dim external light; low reflectivity for bright external light). Furthermore, the PCB 124 may provide control signals to the turn signal light connector 132 to turn on blinking of the corresponding turn signal light. Also, the PCB 124 may provide control signals to the blind-spot detector light connector 134 to turn on the blind-spot detector light, e.g., when a vehicle is detected in the blind spot, and warn the driver of a potentially dangerous driving condition.

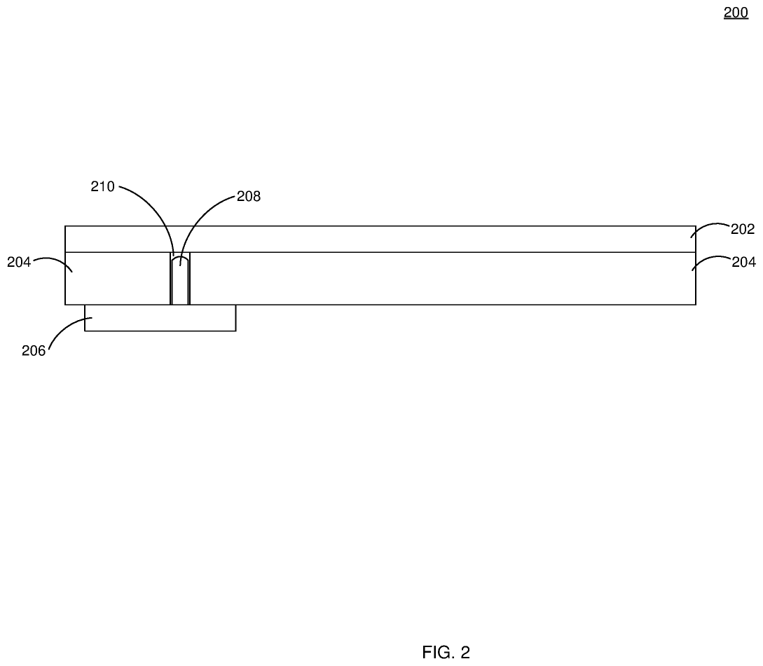

FIG. 2 is a cross-sectional view showing certain parts of the layered structure of a dimmable reflection device 200 incorporating a liquid crystal film, according to some embodiments of the disclosure. The dimmable reflection device 200 may be an example of the curved reflection device 100 shown in FIG. 1A. For simplicity of illustration, the layered structure shown in FIG. 2 are drawn as comprising flat layers. However, it should be understood that the layered structure may comprise curved layers according to some embodiments. As shown, the dimmable reflection device 200 comprises a liquid crystal film 202, a reflective layer 204, a PCB layer 206, and a light sensor 208. The liquid crystal film 202 is attached to the reflective layer 204 using, for example, an optically clear adhesive. The reflective layer 204 may comprise a mirror, which may comprise an indium tin oxide material or a nano silver material, for example. In some embodiments, the reflective layer 204 incorporates an aperture 210 through which light originating from an external source may travel to reach the light sensor 208. The light sensor 208 may be positioned proximate to the aperture 210. In some embodiments, the light sensor 208 is mounted partially or fully within the aperture 210. In other embodiments, the light sensor 208 is mounted outside the aperture 210. In yet other embodiments, the light sensor 208 may be positioned in a different location on the vehicle away from the dimmable reflection device 200. The light sensor 208 provides light intensity measurements to the PCB layer 206, which in turn provides appropriate voltages as output signals to liquid crystal film connectors (not shown) to put the liquid crystal film 202 in an appropriate state to control the reflectivity rate of the dimmable reflection device 200. As shown here, the PCB may be mounted on an underside of the reflective layer 204. In other embodiments, the PCB may be mounted elsewhere within the dimmable reflection device 200.

The dimmable reflection device 200 may comprise additional components not explicitly shown in FIG. 2B to support control of the liquid crystal film 202. For example, the dimmable reflection device 200 may further comprise a battery, a control semiconductor device (i.e., chip), and a DC-AC conversion chip. The battery may provide power to drive electrical circuits and control signals. The control semiconductor device may implement the control circuitry used to receive input signals in the form of light intensity measurements from the light sensor 208 and generate output control signals for driving the liquid crystal film 202. The DC-AC conversion chip may be used to convert direct current control signals into alternate current driving signals for driving the liquid crystal film, in certain embodiments.

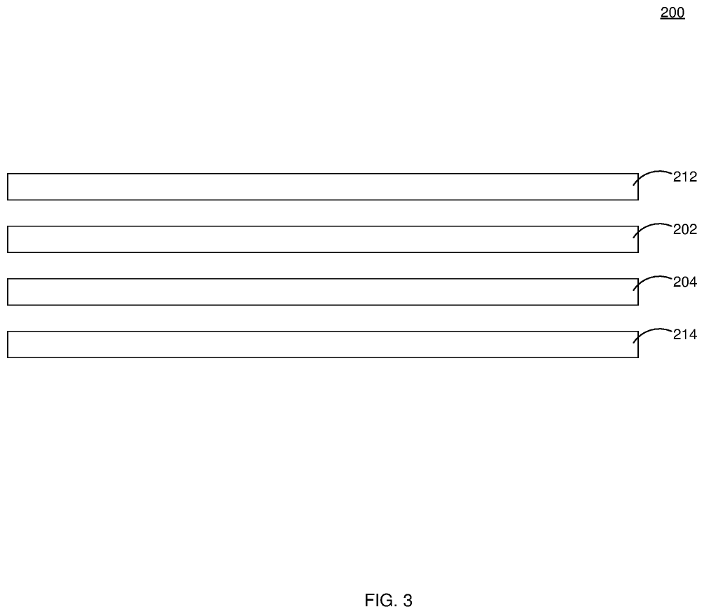

FIG. 3 is different cross-sectional view showing certain parts of the layered structure of the dimmable reflection device 200 incorporating a liquid crystal film, according to some embodiments of the disclosure. Again, the dimmable reflection device 200 may be an example of the curved reflection device 100 shown in FIG. 1A. Also, the layered structure may comprise curved layers, even though flat layers are shown in the present figure for simplicity of illustration. As shown, the dimmable reflection device 200 comprises a cover glass layer 212, the liquid crystal film 202 (previously described), the reflective layer 204 (previously described), and a protective case 214. The cover glass layer 212 may comprise a transparent material such as glass or other material having a hard external surface such a polymer with a scratch-resistant coating. The cover glass layer 212 protects the rest of the layered structure from exposure to the external environment such as water, dust, scratches, etc. The liquid crystal film 202 provides an adjustable transmittance used for changing the overall reflectivity of the dimmable reflection device 200. The reflective layer 204 reflects light that has traveled from the external environment, through the cover glass layer 212 and the liquid crystal film 202, in a reverse direction back through the liquid crystal film 202 and cover glass layer 212 and back out to the external environment. This reflection path may start with an external light source such as headlights of another vehicle and end at the eyes of the driver of the vehicle to which the dimmable reflection device 200 is mounted. The protective case 214 serves to protect the backside (side opposite the light source) of the dimmable reflection device 200.

The dimmable reflection device 200 shown in FIGS. 2 and 3 is an example of an apparatus for proving a dimmable reflection and having a layered structure comprising a curved reflective layer a curved cover glass layer and at least one liquid crystal film positioned between the curved reflective layer and the curved cover glass layer. In some embodiments, each of the at least one liquid crystal film comprises a first substrate layer, a first conductive layer, a first alignment layer, a guest host (GH) liquid crystal layer comprising liquid crystal molecules and dichroic dye molecules, a second alignment layer, a second conductive layer, and a second substrate layer. In some embodiments, each of the at least one liquid crystal film is operable in (1) a vertical state in which the liquid crystal molecules are oriented in a direction perpendicular to a plane corresponding to the liquid crystal film and the layered structure is associated with a first reflectivity rate and (2) a planar state in which the liquid crystal molecules are oriented in a direction parallel to the plane corresponding to the liquid crystal film and the layered structure is associated with a second overall reflectivity rate lower than the first reflectivity rate.

In the vertical state, the liquid crystal molecules and dichroic dye molecules are oriented in the direction perpendicular to a plane of the liquid crystal film. As such, the absorptivity of dye molecules in the liquid crystal material is relatively low, such that incident light has a relatively high transmittance. The intensity of light reaching the reflective layer thus remains substantially unchanged. By contrast, in the planar state, the liquid crystal molecules and dichroic dye molecules are oriented in the direction parallel to the plane of the liquid crystal film. Here, the absorptivity of dye molecules in the liquid crystal material is relatively high, such that incident light has a relatively low transmittance. The intensity of light reaching the reflective layer is thus significantly reduced.

The arrangements shown in FIGS. 2A and 2B, as well as subsequent figures, utilize one or more liquid crystal films characterized by fast response times. The amount of time typically associated with transitioning from the vertical state to the planar state, or from the planar state to the vertical state, is typically on the order of 100 to 200 milliseconds. This represents a response time that is more than 15 times faster than that of electrochromic dimming devices, which typically require a switching time on the order of several seconds, such as 5-6 seconds. The faster response time (at least an order of magnitude faster, compared to electrochromic devices) of the dimmable reflection devices according to embodiments of the present disclosure improves safety, by significantly reducing the amount of time a driver is exposed to reflected, high-intensity lights that may blind or otherwise impact a driver's ability to see while driving and using a rearview mirror.

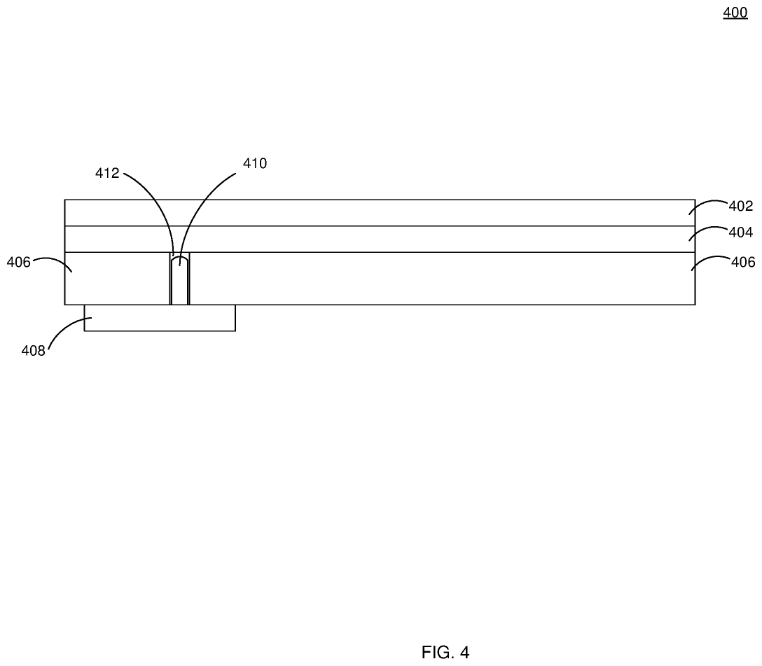

FIG. 4 is a cross-sectional view showing certain parts of the layered structure of a dimmable reflection device 400 incorporating a liquid crystal film and a quarter-wave plate, according to some embodiments of the disclosure. The dimmable reflection device 400 may be an example of the curved reflection device 100 shown in FIG. 1A. For simplicity of illustration, the layered structure shown in FIG. 4 are drawn as comprising flat layers. However, it should be understood that the layered structure may comprise curved layers according to some embodiments. As shown, the dimmable reflection device 400 comprises a liquid crystal film 402, a quarter-wave plate 404, a reflective layer 406, a PCB layer 408, and a light sensor 410. The liquid crystal film 402, quarter-wave plate 404, and reflective layer 406 may be attached together using, for example, an optically clear adhesive. The reflective layer 406 may comprise a mirror and, as shown here, incorporates an aperture 412 through which light originating from an external source may travel to reach the light sensor 410. The light sensor 410 may be positioned proximate to the aperture 412. The light sensor 410 may be positioned elsewhere in other embodiments, as discussed previously. The light sensor 410 provides light intensity measurements to the PCB layer 408, which in turn provides appropriate voltages as output signals to liquid crystal film connectors (not shown) to put the liquid crystal film 402 in an appropriate state to control the reflectivity rate of the dimmable reflection device 400. The PCB may be mounted at different locations, as previously discussed.

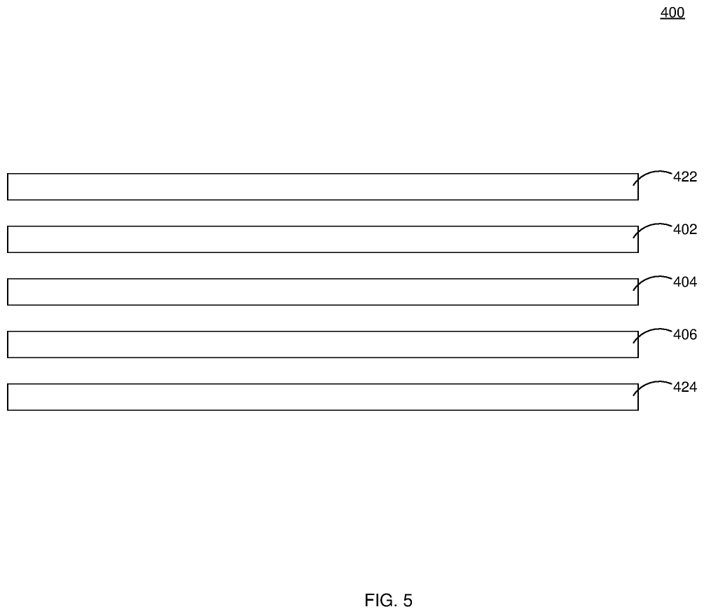

FIG. 5 is different cross-sectional view showing certain parts of the layered structure of the dimmable reflection device 400 incorporating a liquid crystal film and a quarter-wave plate, according to some embodiments of the disclosure. Again, the dimmable reflection device 400 may be an example of the curved reflection device 100 shown in FIG. 1A. Also, the layered structure may comprise curved layers, even though flat layers are shown in the present figure for simplicity of illustration. As shown, the dimmable reflection device 400 comprises a cover glass layer 422, the liquid crystal film 402 (previously described), the quarter-wave plate 404 (previously described), the reflective layer 406 (previously described), and a protective case 424. The cover glass layer 422 may comprise a transparent material such as glass or other material having a hard external surface such a polymer with a scratch-resistant coating and serves to protect the rest of the layered structure from exposure to the external environment such as water, dust, scratches, etc. The combination of the liquid crystal film 402, the quarter-wave plate 404, and the reflective layer 406 operates to provide an adjustable rate of reflectivity, as explained in more detail in subsequent sections. The protective case 424 serves to protect the backside (side opposite the light source) of the dimmable reflection device 400.

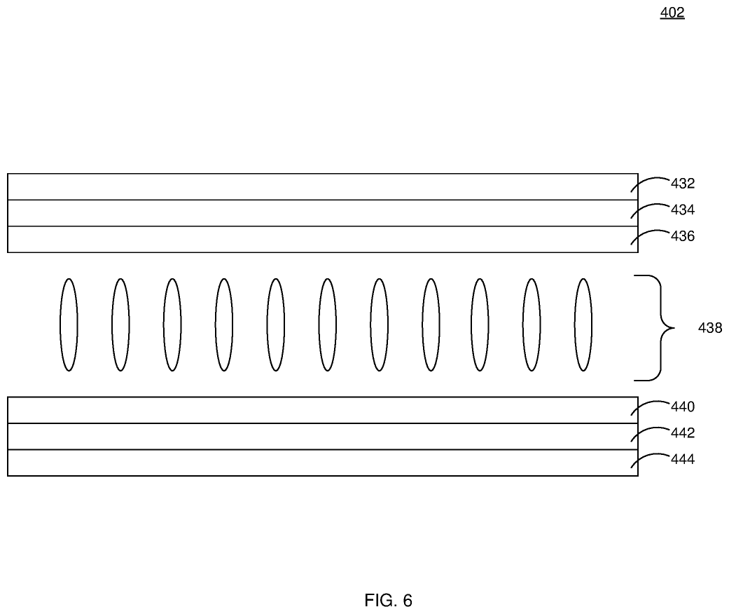

FIG. 6 illustrates the vertical state of the liquid crystal film 402 within the layered structure of the dimmable reflection device 400 incorporating a liquid crystal film and a quarter-wave plate, according to some embodiments of the disclosure. As shown, the liquid crystal film 402 comprises a first substrate layer 432, a first conductive layer 434, a first alignment layer 436, a guest host (GH) liquid crystal layer 438 comprising liquid crystal molecules and dichroic dye molecules, a second alignment layer 440, a second conductive layer 442, and a second substrate layer 444.

In the vertical state, as shown, the long axis of the liquid crystal molecules and the dye molecules are perpendicular to the plane corresponding to the liquid crystal film 402. As such, incident light passes through the liquid crystal film 402 with little or no absorption. Unpolarized light passes through and exits the liquid crystal film 402 as unpolarized light. The unpolarized light then passes through the quarter-wave plate 404 (shown in FIG. 5) and reaches the reflective layer 406 (shown in FIG. 5) as unpolarized light. After being reflected by the reflective layer 406, the unpolarized light passes through the quarter-wave plate again, then through the liquid crystal film 402. The unpolarized, reflected light passes through the liquid crystal film 402 with little or no absorption. The resulting reflected light is only slightly lower in brightness than the incident light. The overall reflectivity rate of the dimmable reflection device 400 associated with the vertical state is therefore relatively high and can be 40% or more.

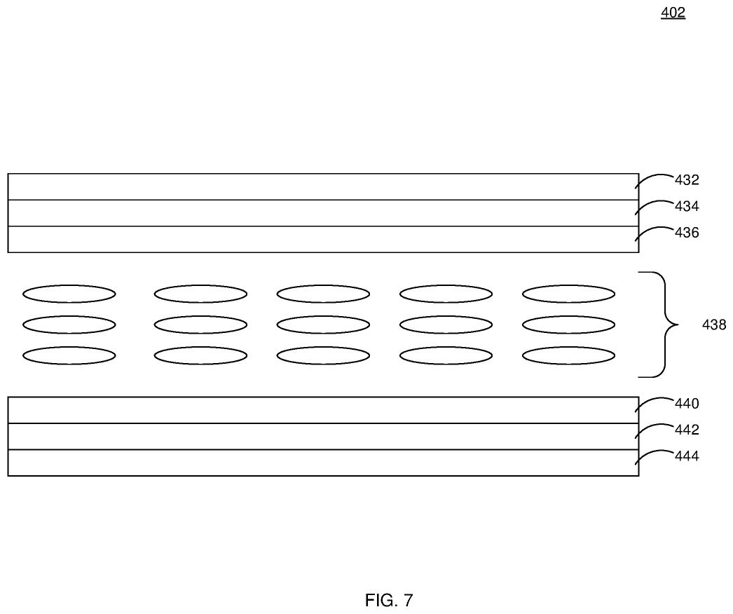

FIG. 7 illustrates the planar state of the liquid crystal film 402 within the layered structure of the dimmable reflection device 400 incorporating a liquid crystal film and a quarter-wave plate, according to some embodiments of the disclosure. In the planar state, the long axis of the liquid crystal molecules and the dye molecules is parallel to the plane corresponding to the liquid crystal film 402. Incident light passes through the liquid crystal film 402 with relatively high absorption. Specifically, the liquid crystal film 402 converts unpolarized incident light into linearly polarized light. This occurs because the dichroic dye molecules in the GH liquid crystals absorb linearly polarized light parallel to the long axis of the liquid crystal molecules. The remaining light is thus linearly polarized, with a polarization direction mainly parallel to the short axis of the liquid crystal molecules of the GH liquid crystal layer 438. The linearly polarized light then passes through the quarter-wave plate 404 (shown in FIG. 5), which converts the linearly polarized light in to, e.g., right-handed circularly polarized (RHC) light. The reflective layer 406 (shown in FIG. 5) symmetrically reflects the circularly polarized light, which changes its polarization rotation, e.g., to left-handled circularly polarized (LHC) light. The reflected, circularly polarized light reaches quarter-wave plate 404 and is converted to linearly polarized light. The reflected, linearly polarized light has a polarization direction that is 90-degree offset from the polarization direction of the incident, linearly polarized light. Thus, the polarization direction of the reflected, linearly polarized light is parallel to the long axis of the liquid crystal molecules of the GH liquid crystal layer 438. As mentioned before, the dichroic dye molecules in the GH liquid crystals absorb linearly polarized light parallel to the long axis of the liquid crystal molecules. As such, the reflected, linearly polarized light once again experiences high absorption as it passes through the liquid crystal film 402. The overall reflectivity rate of the dimmable reflection device 400 associated with the planar state is low and can be 10% or less, significantly lower than that associated with the vertical state.

The dimmable reflection device 400 shown in FIGS. 4-7 is an example of an apparatus for proving a dimmable reflection and having a layered structure comprising a curved reflective layer a curved cover glass layer and at least one liquid crystal film positioned between the curved reflective layer and the curved cover glass layer, wherein the at least one liquid crystal film comprises a single GH liquid crystal layer, and the single GH liquid crystal layer comprises non-cholesteric liquid crystal molecules having a non-helical structure, and wherein the layered structure further comprises a quarter-wave layer positioned between the single GH liquid crystal layer and the curved reflective layer. In some embodiments, each of the at least one liquid crystal film comprises a first substrate layer, a first conductive layer, a first alignment layer, a guest host (GH) liquid crystal layer comprising liquid crystal molecules and dichroic dye molecules, a second alignment layer, a second conductive layer, and a second substrate layer. In some embodiments, each of the at least one liquid crystal film is operable in (1) a vertical state in which the liquid crystal molecules are oriented in a direction perpendicular to a plane corresponding to the liquid crystal film and the layered structure is associated with a first reflectivity rate and (2) a planar state in which the liquid crystal molecules are oriented in a direction parallel to the plane corresponding to the liquid crystal film and the layered structure is associated with a second overall reflectivity rate lower than the first reflectivity rate.

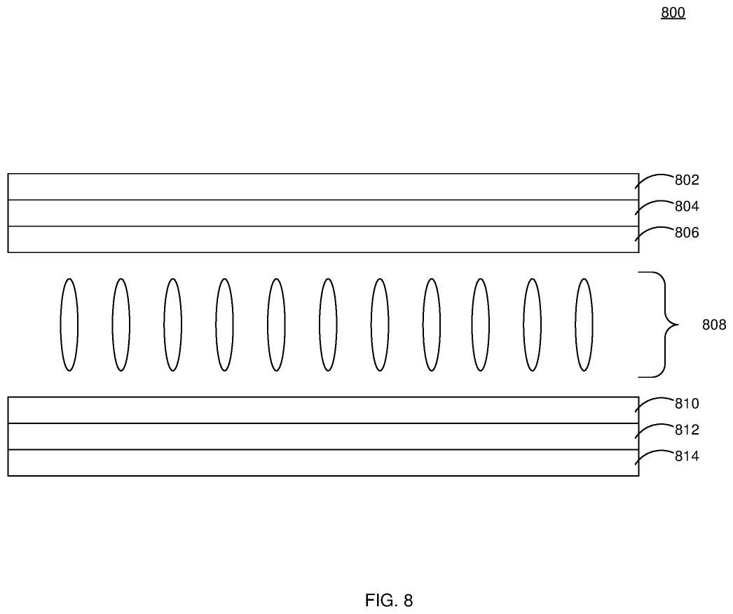

FIG. 8 illustrates the vertical state of the liquid crystal film within the layered structure of a dimmable reflection device incorporating a liquid crystal film 800 comprising cholesteric liquid crystal molecules having a helical structure, according to some embodiments of the disclosure. The layered structure may be similar to that of the dimmable reflection device 200 shown in FIGS. 2 and 3. However, the liquid crystal film 800 comprises cholesteric liquid crystal molecules having a helical structure. As shown, the liquid crystal film 800 comprises a first substrate layer 802, a first conductive layer 804, a first alignment layer 806, a guest host (GH) liquid crystal layer 808 comprising liquid crystal molecules and dichroic dye molecules, a second alignment layer 810, a second conductive layer 812, and a second substrate layer 814. In some embodiments, the cholesteric liquid crystal molecules are implemented as a mixture of guest-host (GH) liquid crystals and a chiral agent/dopant.

In the vertical state, as shown, the long axis of the liquid crystal molecules and the dye molecules is perpendicular to the plane corresponding to the liquid crystal film 800. As such, incident light passes through the liquid crystal film with little or no absorption. Unpolarized light passes through and exits the liquid crystal film 800 as unpolarized light. The unpolarized light reaches the reflective layer 204 (shown in FIG. 3) as unpolarized light. After being reflected by the reflective layer 204, the unpolarized light passes through the liquid crystal film 800 again. The unpolarized, reflected light passes through the liquid crystal film 800 with little or no absorption. The resulting reflected light is only slightly lower in brightness than the incident light. The overall reflectivity rate of the dimmable reflection device associated with the vertical state is therefore relatively high and can be 40% or more.

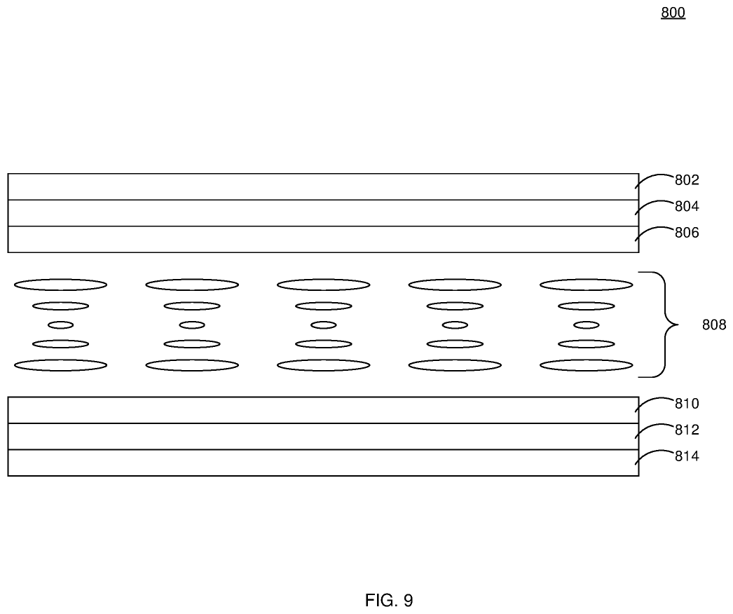

FIG. 9 illustrates the planar state of the liquid crystal film within the layered structure of a dimmable reflection device incorporating the liquid crystal film 800 comprising cholesteric liquid crystal molecules having a helical structure, according to some embodiments of the disclosure. Here, the dichroic dye molecules in the GH liquid crystals absorb light in a direction parallel to the long axis of the liquid crystal molecules. In the planar state, the helical structure of the liquid crystal molecules absorb incident light of different polarization directions parallel to the plane corresponding to the liquid crystal film, resulting in a relatively high absorption rate. After being reflected by the reflective layer 204 (shown in FIG. 3), the reflected, attenuated light experiences the high absorption rate associated with the planar state of the helical structure of the liquid crystal molecules within the liquid crystal film once again. Here, the overall reflectivity rate of the dimmable reflection device associated with the planar state may adjusted to be between 10% and 65%.

FIGS. 8 and 9 illustrate the operation of an example of a dimmable reflection device having a single GH liquid crystal layer comprising cholesteric liquid crystal molecules having a helical structure. In certain embodiments, in the planar state, the cholesteric liquid crystal molecules of the single GH liquid crystal layer are configured to absorb a portion of unpolarized light originating from a first side of the layered structure to generate attenuated, unpolarized light. In some embodiments, the curved reflective layer is configured to reflect a portion of the attenuated, unpolarized light, to generate reflected, attenuated, polarized. The cholesteric liquid crystal molecules of the single GH liquid crystal layer may be configured to absorb a portion of the reflected, attenuated, polarized light, to generate resultant reflected light directed toward the first side of the layered structure.

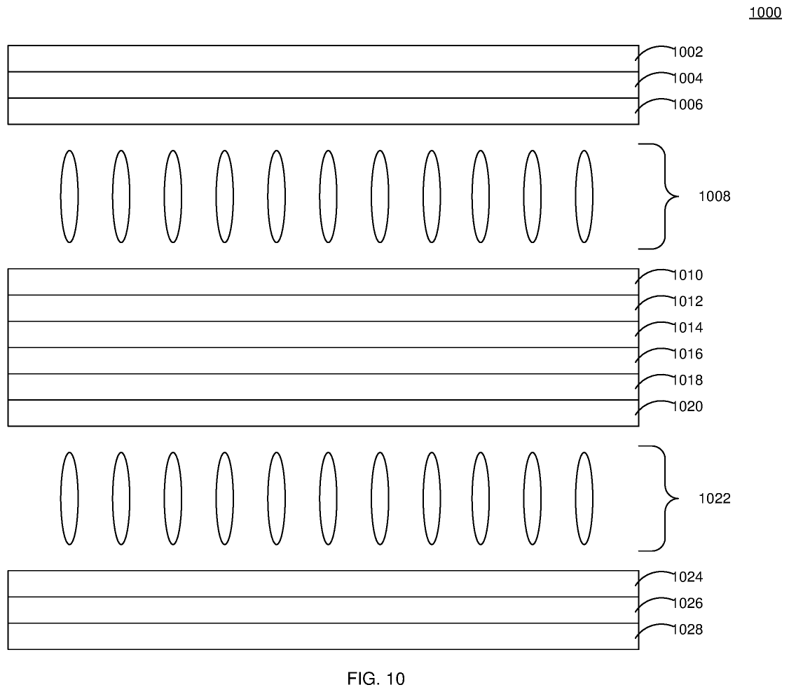

FIG. 10 illustrates the vertical state of a first liquid crystal film and a second liquid crystal film within the layered structure of a dimmable reflection device, according to some embodiments of the disclosure. The layered structure may be similar to that of the dimmable reflection device 200 shown in FIGS. 2 and 3. However, instead of one liquid crystal film, two liquid crystal films are employed. In some embodiments, the at least one liquid crystal film comprises a first GH liquid crystal layer and a second GH liquid crystal layer, and both the first GH liquid crystal layer and the second GH liquid crystal layer comprise non-cholesteric liquid crystal molecules having a non-helical structure.

As shown, a multi-film structure 1000 comprises a first substrate layer 1002, a first conductive layer 1004, a first alignment layer 1006, a first guest host (GH) liquid crystal layer 1008 comprising liquid crystal molecules and dichroic dye molecules, a second alignment layer 1010, a second conductive layer 1012, a second substrate layer 1014, a third substrate layer 1016, a third conductive layer 1018, a third alignment layer 1020, a second GH liquid crystal layer 1022 comprising liquid crystal molecules and dichroic dye molecules, a fourth alignment layer 1024, a fourth conductive layer 1026, and a fourth substrate layer 1028. Here, the alignment direction of the first alignment layer 1006 and the second alignment layer 1010 is perpendicular to the alignment direction of the third alignment layer 1020 and the fourth alignment layer 1024. In other words, the first alignment layer 1006 and the second alignment layer 1010 share a common alignment direction (first alignment direction). The third alignment layer 1020 and the fourth alignment layer 1024 also share a common alignment direction (second alignment direction). The second alignment direction is perpendicular to the first alignment direction.

In the vertical state, as shown, the long axis of the liquid crystal molecules and the dye molecules of both first liquid crystal film and the second liquid crystal film is perpendicular to the plane corresponding to each liquid crystal films. As such, incident light passes through the liquid crystal films with little or no absorption. Unpolarized light passes through and exits the liquid crystal films as unpolarized light. The unpolarized light reaches the reflective layer 204 (shown in FIG. 3) as unpolarized light. After being reflected by the reflective layer 204, the unpolarized light passes through the first liquid crystal film and the second liquid crystal film again. The unpolarized, reflected light passes through the first and second liquid crystal films with little or no absorption. The resulting reflected light is only slightly lower in brightness than the incident light.

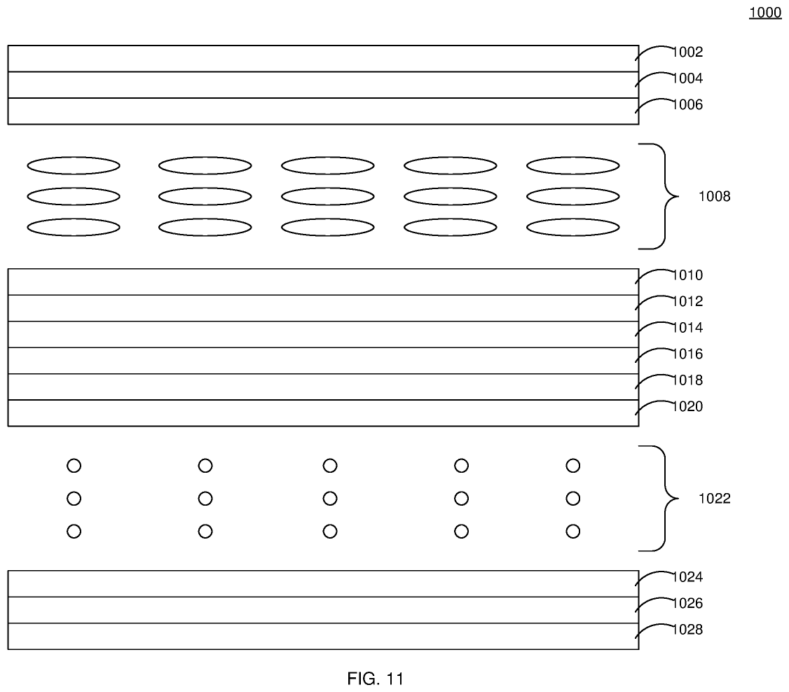

FIG. 11 illustrates the planar state of a first liquid crystal film and a second liquid crystal film within the layered structure of a dimmable reflection device, according to some embodiments of the disclosure. Here, the liquid crystal molecules and dichroic molecules in the first GH liquid crystal layer 1008 and the second GH liquid crystal layer 1022 are both parallel to a plane corresponding to each liquid crystal film. As such, both the first GH liquid crystal layer 1008 and the second GH liquid crystal layer 1022 have high absorption rates. Specifically, the first GH liquid crystal layer 1008 converts unpolarized incident light into linearly polarized light. This occurs because the dichroic dye molecules in the GH liquid crystals absorb linearly polarized light parallel to the long axis of the liquid crystal molecules of first GH liquid crystal layer 1008. The remaining light is thus linearly polarized, with a polarization direction mainly parallel to the short axis of the liquid crystal molecules of first GH liquid crystal layer 1008. Because the first GH liquid crystal layer 1008 and the second GH liquid crystal layer 1022 have perpendicular alignment directions, the second GH liquid crystal layer 1022 absorbs most of this linearly polarized light, which has a polarization direction parallel to the long axis of the liquid crystal molecules of the second GH liquid crystal layer 1022. The resulting reflectivity rate may be adjusted between 8% and 70%.

FIGS. 10 and 11 illustrate the operation of an example of a dimmable reflection device having a first GH liquid crystal layer and a second GH liquid crystal layer, with both the first GH liquid crystal layer and the second GH liquid crystal layer comprising non-cholesteric liquid crystal molecules having a non-helical structure. In some embodiments, in the planar state, the non-cholesteric liquid crystal molecules of the first GH liquid crystal layer are configured to attenuate light originating from a first side of layered structure, by absorbing light in a first linear polarization orientation, to generate first attenuated light having reduced intensity in the first linear polarization orientation. The non-cholesteric liquid crystal molecules of the second GH liquid crystal layer may be configured to further attenuate the first attenuated light, by absorbing light in a second linear polarization orientation, to generate second attenuated light having reduced intensity in both the first and the second linear polarization orientations. The curved reflective layer may be configured to reflect the second attenuated light, to generate reflected, attenuated light. In some embodiments, the non-cholesteric liquid crystal molecules of the second GH liquid crystal layer are configured to further attenuate the reflected, attenuated light, by absorbing light in the second linear polarization orientation, to generate third attenuated light having further reduced intensity in the second linear polarization orientation. The non-cholesteric liquid crystal molecules of the first GH liquid crystal layer may be configured to further attenuate the third attenuated light, by absorbing light in the first linear polarization orientation, to generate fourth attenuated light having further reduced intensity in both the first and the second linear polarization orientations, as resultant reflected light directed toward the first side of the layered structure.

In some embodiments, the at least one liquid crystal film described in various arrangements above is configured to be driven to the vertical state by applying a first voltage to the first conductive layer and the second conductive layer, and the at least one liquid crystal film is configured to be driven to the planar state by a second voltage to the first conductive layer and the second conductive layer. In certain embodiments, the liquid crystal molecules are negative GH liquid crystal molecules, and the first voltage is 0V, and the second voltage is in a range of 3V to 10V. In some embodiments, the liquid crystal molecules are negative GH liquid crystal molecules, the at least one liquid crystal film can reach the planar state while in a power-on state (e.g., a voltage being applied in a range of 3V to 10V), and the at least one liquid crystal film can maintain the vertical state while in a power-off state (e.g., a voltage being applied of approximately 0V).

In other embodiments, the liquid crystal molecules are positive GH liquid crystal molecules, and the first voltage is in a range of 3V to 10V, and the second voltage is 0V. In some embodiments, the liquid crystal molecules are positive GH liquid crystal molecules, the at least one liquid crystal film can reach the vertical state while in a power-on state (e.g., a voltage being applied in a range of 3V to 10V), and the at least one liquid crystal film can maintain the planar state while in a power-off state (e.g., a voltage being applied of approximately 0V).

An apparatus for proving a dimmable reflection and having a layered structure as discussed previously in various embodiments may further comprise a control circuit coupled to the first conductive layer and the second conductive layer and configured to provide appropriate voltages to the first conductive layer and the second conductive layer, to operate each of the at least one liquid crystal film in the vertical state and the planar state at different times. In some embodiments, the apparatus further comprises a light sensor coupled to the control circuit, the control circuit configured to operate each of the at least one liquid crystal film in the vertical state or the planar state based on a light intensity measurement obtained from the light sensor. In some embodiments, the layered structure comprises a curved reflective layer, and the curved reflective layer includes an aperture. The light sensor may be configured to capture light originating from an external source and propagating through the aperture. In additional embodiments, a vehicle comprising the apparatus for proving a dimmable reflection as described may be implemented. For example, the apparatus for proving dimmable reflection may be built as a side-mounted exterior rearview mirror of the vehicle.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device or system is capable of manipulating or transforming signals, typically represented as physical electronic, electrical, or magnetic quantities within memories, registers, or other information storage devices, transmission devices, or display devices of the special purpose computer or similar special purpose electronic computing device or system.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure as defined by the appended claims. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

What is claimed is:

1. An apparatus for proving a dimmable reflection and having a layered structure comprising:
a curved reflective layer;
a curved cover glass layer; and
at least one liquid crystal film positioned between the curved reflective layer and the curved cover glass layer, wherein each of the at least one liquid crystal film comprises a first substrate layer, a first conductive layer, a first alignment layer, a guest host (GH) liquid crystal layer comprising liquid crystal molecules and dichroic dye molecules, a second alignment layer, a second conductive layer, and a second substrate layer,
wherein each of the at least one liquid crystal film is operable in (1) a vertical state in which the liquid crystal molecules are oriented in a direction perpendicular to a plane corresponding to the liquid crystal film and the layered structure is associated with a first reflectivity rate and (2) a planar state in which the liquid crystal molecules are oriented in a direction parallel to the plane corresponding to the liquid crystal film and the layered structure is associated with a second overall reflectivity rate lower than the first reflectivity rate.

2. The apparatus of claim 1, wherein the at least one liquid crystal film comprises a single GH liquid crystal layer, and the single GH liquid crystal layer comprises non-cholesteric liquid crystal molecules having a non-helical structure.

3. The apparatus of claim 2, wherein the layered structure further comprises a quarter-wave layer positioned between the single GH liquid crystal layer and the curved reflective layer.

4. The apparatus of claim 3, wherein in the planar state:
the non-cholesteric liquid crystal molecules of the single GH liquid crystal layer are configured to absorb light originating from a first side of the layered structure, to generate attenuated light polarized in a first linear polarization orientation;
the quarter-wave layer is configured to convert the attenuated light to circularly polarized light;
the curved reflective layer is configured to reflect a portion of the circularly polarized light, to generate reflected, circularly polarized light;
the quarter-wave layer is configured to convert the reflected, circularly polarized light to generate reflected, attenuated light polarized in a second linear polarization orientation perpendicular to the first linear polarization orientation; and
the non-cholesteric liquid crystal molecules of the single GH liquid crystal layer are configured to further absorb a portion of the reflected, attenuated light, to generate resultant reflected light directed toward the first side of the layered structure.

5. The apparatus of claim 1, wherein the at least one liquid crystal film comprises a single GH liquid crystal layer, and the single GH liquid crystal layer comprises cholesteric liquid crystal molecules having a helical structure.

6. The apparatus of claim 5, wherein in the planar state:
the cholesteric liquid crystal molecules of the single GH liquid crystal layer are configured to absorb a portion of unpolarized light originating from a first side of the layered structure to generate attenuated, unpolarized light;
the curved reflective layer is configured to reflect a portion of the attenuated, unpolarized light, to generate reflected, attenuated, polarized; and
the cholesteric liquid crystal molecules of the single GH liquid crystal layer are configured to absorb a portion of the reflected, attenuated, polarized light, to generate resultant reflected light directed toward the first side of the layered structure.

7. The apparatus of claim 1, wherein the at least one liquid crystal film comprises a first GH liquid crystal layer and a second GH liquid crystal layer, and both the first GH liquid crystal layer and the second GH liquid crystal layer comprise non-cholesteric liquid crystal molecules having a non-helical structure.

8. The apparatus of claim 7, wherein in the planar state:
the non-cholesteric liquid crystal molecules of the first GH liquid crystal layer are configured to attenuate light originating from a first side of layered structure, by absorbing light in a first linear polarization orientation, to generate first attenuated light having reduced intensity in the first linear polarization orientation;
the non-cholesteric liquid crystal molecules of the second GH liquid crystal layer are configured to further attenuate the first attenuated light, by absorbing light in a second linear polarization orientation, to generate second attenuated light having reduced intensity in both the first and the second linear polarization orientations;
the curved reflective layer is configured to reflect the second attenuated light, to generate reflected, attenuated light;
the non-cholesteric liquid crystal molecules of the second GH liquid crystal layer are configured to further attenuate the reflected, attenuated light, by absorbing light in the second linear polarization orientation, to generate third attenuated light having further reduced intensity in the second linear polarization orientation; and
the non-cholesteric liquid crystal molecules of the first GH liquid crystal layer are configured to further attenuate the third attenuated light, by absorbing light in the first linear polarization orientation, to generate fourth attenuated light having further reduced intensity in both the first and the second linear polarization orientations, as resultant reflected light directed toward the first side of the layered structure.

9. The apparatus of claim 1, wherein the curved reflective layer comprise a mirror.

10. The apparatus of claim 1, wherein the at least one liquid crystal film is configured to be driven to the vertical state by applying a first voltage to the first conductive layer and the second conductive layer, and the at least one liquid crystal film is configured to be driven to the planar state by a second voltage to the first conductive layer and the second conductive layer.

11. The apparatus of claim 10, wherein the liquid crystal molecules are negative GH liquid crystal molecules, and the first voltage is 0V, and the second voltage is in a range of 3V to 10V.

12. The apparatus of claim 10, wherein the liquid crystal molecules are positive GH liquid crystal molecules, and the first voltage is in a range of 3V to 10V, and the second voltage is 0V.

13. The apparatus of claim 1, further comprising a control circuit coupled to the first conductive layer and the second conductive layer and configured to provide appropriate voltages to the first conductive layer and the second conductive layer, to operate each of the at least one liquid crystal film in the vertical state and the planar state at different times.

14. The apparatus of claim 13, further comprising a light sensor coupled to the control circuit, the control circuit configured to operate each of the at least one liquid crystal film in the vertical state or the planar state based on a light intensity measurement obtained from the light sensor.

15. The apparatus of claim 14, wherein the curved reflective layer includes an aperture, and the light sensor is configured to capture light originating from an external source and propagating through the aperture.

16. A vehicle comprising the apparatus of claim 1.
